(19) United States
(12) Patent Application Publication
(10) Pub. No.: US 2007/0287094 A1
(43) Pub. Date: Dec. 13, 2007

(54) Planographic Printing Plate, Planographic Printing Plate Material, Support for Planographic Printing Plate Material, and Planographic Printing Method

(75) Inventor: Takahiro Mori, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/758,073

(22) Filed: Jun. 5, 2007

(30) Foreign Application Priority Data
Jun. 12, 2006 (JP) 2006-162033

(51) Int. Cl. G03C 1/00

(52) U.S. Cl. 430/270.1; 101/454

(57) ABSTRACT

An objective is to provide a planographic printing plate material exhibiting excellent properties such as printing durability, resistance to chemicals and anti-stain at the beginning of printing via restart of printing, and also a planographic printing plate exhibiting excellent properties such as printing durability, resistance to chemicals and anti-stain at the beginning of printing via restart of printing. Disclosed is a planographic printing plate comprising a support and provided thereon, an image portion and a non-image portion, wherein the non-image portion comprises a water-soluble phosphobetaine compound.

This application claims priority from Japanese Patent Application No. 2006-162033 filed on Jun. 12, 2006, which is incorporated hereinto by reference.

### TECHNICAL FIELD

The present invention relates to a planographic printing plate and a planographic printing plate material, and particularly to a printing plate material capable of forming an image via a computer to plate (CTP) system and the planographic printing plate prepared employing the printing plate material.

### BACKGROUND

A printing plate material for the CTP system, which is inexpensive, can be easily handled, and has a printing ability comparable with that of a PS plate, is required accompanied with the digitization of printing data. Recently, printing plate materials applied to various CTP systems (hereinafter, referred to simply as CTP) by recording with violet laser or infrared laser have been proposed.

Of these CTP systems, there is a CTP system called a wet type CTP in which solubility of the image formation layer of a printing plate material is varied by imagewise exposure, followed by development with a liquid developer to form an image. However, this system has various problems, in that an exclusive alkali developer is required as in conventional PS plates, developability of developer used varies due to the developer conditions such as temperature or fatigue degree of the developer, image reproduction is not obtained, or operation under room light is restricted.

On the other hand, a so-called processless CTP, which does not require special development (including development-on-press), has been developed. The processless CTP has been noticed, since it can be applied to a printing press for a direct imaging (DI) system, in which an image is formed directly on a printing plate material mounted on the printing press to obtain a printing plate, and printing is carried out employing the printing plate.

As a processless CTP, there is an ablation type CTP, for example, one which is disclosed in for example, Japanese Patent O.P.I. Publication Nos. 8-507727, 6-186750, 6-199064, 7-314934, 10-58636 and 10-244773.

These references disclose that a hydrophilic layer or a lipophilic layer is multilayered as a surface layer on a substrate. In the case of a lipophilic layer containing a light-to-heat conversion material formed below a hydrophilic layer as a surface layer, the hydrophilic layer is imagewise exposed to imagewise ablate the hydrophilic layer via explosive heat generation of the hydrophilic layer, whereby the lipophilic layer is exposed to form image portions. However, since the ablated matter is scattered from a printing plate during exposure, an exposure device required to be equipped with a mechanism of removing the ablated matter via suction lacks versatility. There is also a problem such that sensitivity is generally low, since large energy is required for ablation, and this causes a lack of lowered productivity in the case of employing the above-described exposure device.

On the other hand, printing plate materials in which images are possible to be formed with no ablation, and a developing treatment with a developer and a wiping treatment are not required are also being developed. For example, disclosed is a processless CTP (hereinafter, referred to as development-on-press CTP) capable of developing with dampening water by employing thermoplastic particles and a water-soluble binder for an image formation layer (refer to Patent Document 1).

Since an exposure device does not have to install a special mechanism for such the development-on-press CTP, the same exposure device as one for a wet type thermal CTP is usable, and a design for comparatively high sensitivity is also possible, whereby sufficient exposure productivity can be obtained.

The common structure of development-on-press CTP is a structure in which an image formation layer capable of development-on-press is provided on the hydrophilic surface of a substrate. The image formation layer capable of development-on-press comprises a photosensitive hydrophobic precursor such as a microcapsule encapsulating thermoplastic hydrophobic resin particles and a hydrophobic compound, and a development-on-press accelerator.

The above-described photosensitive hydrophobic precursor capable of producing fusion by heat generated via infrared laser exposure, and producing adhesion of an image formation layer itself onto the hydrophilic surface of a substrate via cross-linkage and polymerization produces an effect of obtaining image intensity in which the layer is not removed even by a contact with a water roller and an ink roller in a printing press.

However, there was a substantial problem such that a development-on-press CTP with such the photosensitive hydrophobic precursor exhibited inferior heat storing stability and on-press developability deteriorated after storing at high temperature.

In order to improve heat storing stability, provided is a method by which a softening point and a melting point of thermoplastic hydrophobic resin particles are raised, but this method deteriorates sensitivity largely.

Heat storing stability can also improved by increasing a content ratio of a water-soluble compound in an image formation layer, but this method also deteriorates sensitivity. Further, not only strength at the image portion and water resistance are degraded, but also printing durability and resistance to chemicals are deteriorated since a large amount of the water-soluble compound is included in the inside of an image portion coated layer formed via exposure.

A method of providing a hydrophilic subbing layer is disclosed (refer to Patent Document 2), but heat storing stability is still insufficient, even though exemplified compounds are employed.

Therefore, a technique concerning a development-on-press CTP by which heat storing stability is improved and printing durability and resistance to chemicals are also satisfied has been demanded. On the one hand, there is another problem such that background contamination is generated at the beginning of printing via restart of printing after standby time, whereby printability becomes insufficient. On the other hand, known is a method in which an anti-stain property during printing, printing durability and so forth are upgraded by improving a hydrophilic layer provided on a support (refer to Patent Documents 3 and 4). However, it was difficult to prepare a planographic printing plate material satisfying resistance to chemicals, heat storing stability and a anti-stain property at the beginning of printing via restart of printing while maintaining excellent developability.

(Patent Document 1) Japanese Patent Document O.P.I. Publication No. 9-123387

(Patent Document 2) Japanese Patent Document O.P.I. Publication No. 2000-122271

(Patent Document 3) Japanese Patent Document O.P.I. Publication No. 2002-162732

(Patent Document 4) Japanese Patent Document O.P.I. Publication No. 2003-118252

### SUMMARY

The present invention was made on the basis of the above-described situation. It an object of the present invention to provide a planographic printing plate material exhibiting excellent properties such as printing durability, resistance to chemicals and anti-stain at the beginning of printing via restart of printing, and also a planographic printing plate exhibiting excellent properties such as printing durability, resistance to chemicals and anti-stain at the beginning of printing via restart of printing. Also disclosed is a planographic printing plate comprising a support and provided thereon, an image portion and a non-image portion, wherein the non-image portion comprises a water-soluble phosphobetaine compound.

### Description of the Preferred Embodiments

The above object of the present invention is accomplished by the following structures.

(Structure 1) A planographic printing plate comprising a support and provided thereon, an image portion and a non-image portion, wherein the non-image portion comprises a water-soluble phosphobetaine compound.

(Structure 2) The planographic printing plate of Structure 1, wherein the water-soluble phosphobetaine compound is a compound comprising a group represented by the following Formula (2):

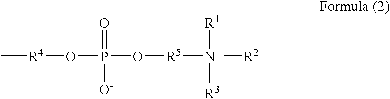

wherein R¹, R² and R³ each are the same group or a different group, representing an alkyl group or a hydroxyalkyl group having 1-8 carbon atoms; R⁴ represents —(CH₂—CHR⁶O)ₘ—(CH₂-CHR⁶)— where R⁶ represents a hydrogen atom, a methyl group or an ethyl group, and m is an integer of 0-10; and R⁵ represents —(CH₂)_{g}— where g is an integer of 0-10.

(Structure 3) A planographic printing plate material utilized for the planographic printing plate of Structure 1 or 2, comprising the support and provided thereon, an image formation layer, and the water-soluble phosphobetaine compound between the support and the image formation layer.

(Structure 4) The planographic printing plate material of Structure 3, wherein the image formation layer comprises the water-soluble phosphobetaine compound.

(Structure 5) The planographic printing plate material of Structure 3, wherein the support comprises a hydrophilic layer containing the water-soluble phosphobetaine compound on an image formation layer side of the support.

(Structure 6) The planographic printing plate material of any one of Structures 3-5, wherein the water-soluble phosphobetaine compound is a compound comprising a group represented by the following Formula (2):

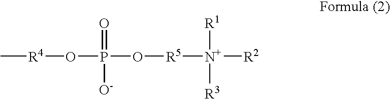

wherein each of R¹, R² and R³ each are the same group or a different group, representing an alkyl group or a hydroxyalkyl group having 1-8 carbon atoms; R⁴ represents —(CH₂—CHR⁶O)_{m—(CH}₂—CHR⁶)— where R⁶ represents a hydrogen atom, a methyl group or an ethyl group, and m is an integer of 0-10; and R⁵ represents —(CH₂)_{g}— where g is an integer of 0-10.

(Structure 7) A support utilized for the planographic printing plate material of Structure 5.

(Structure 8) A planographic printing method comprising the step of conducting a planographic printing process employing the planographic printing plate of Structure 1.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

The preferred embodiments of the present invention will be explained below, but the present invention is not limited thereto.

It is a feature in the present invention that a planographic printing plate comprising a support and provided thereon, an image portion and a non-image portion, wherein the non-image portion comprises a water-soluble phosphobetaine compound.

As to the planographic printing, the image portion of the present invention is a portion in which printing ink is received, and the non-image portion is a portion in which no printing ink is received. That is, in the case of the planographic printing to conduct printing by supplying dampening water and printing ink to a planographic printing, the non-image portion is a portion in which dampening water is received and retained, and no printing ink is received.

What the non-image portion comprises a water-soluble phosphobetaine compound in the present invention means that the water-soluble phosphobetaine compound is present at least on the surface of the non-image portion.

According to printing plates of the present invention, printability such as prevention of background contaminations generated at the beginning of printing via restart of printing after a long standby duration, and prevention of ink adhesion to inter-dot area at comparatively high density portions is improved when the non-image portion comprises a water-soluble phosphobetaine compound. There are the following modes to acquire a planographic printing plate comprising a water-soluble phosphobetaine compound at least on the non-image portion surface. As a mode, utilized is a planographic printing plate material comprising a support and provided thereon, an image formation layer, and a water-soluble phosphobetaine compound between this support and this image formation layer to conduct a print-making processing for this planographic printing plate material. As another mode, the image portion and the non-image portion are formed on a support employing a conventional planographic printing plate material to subsequently supply a water-soluble phosphobetaine compound to the non-image portion.

What a planographic printing plate material comprises a water-soluble phosphobetaine compound between this support and this image formation layer, as described above, means that the water-soluble phosphobetaine compound is present on the interface between the support and the image formation layer. When the image formation layer is removed via a print-making processing, the water-soluble phosphobetaine compound is allowed to be present on the exposed support surface, that is, the non-image portion surface via presence of the water-soluble phosphobetaine compound on the interface between the support and the image formation layer.

As the mode to make a water-soluble phosphobetaine compound to be present on the interface between a support and an image formation layer, there are modes such that the image formation layer of the planographic printing plate material contains the water-soluble phosphobetaine compound, and the support comprises a hydrophilic layer containing the water-soluble phosphobetaine compound on the image formation layer side of the support.

When the image formation layer contains the water-soluble phosphobetaine compound, the water-soluble phosphobetaine compound contained in the image formation layer is in contact with the support via the image formation layer surface, and the water-soluble phosphobetaine compound is partly adsorbed to the support surface. Therefore, the water-soluble phosphobetaine compound remains present on the exposed support surface (non-image portion) even after removing the image formation layer via print-making.

On the other hand, when the support comprises a hydrophilic layer containing the water-soluble phosphobetaine compound on the image formation layer side of the support, the image formation layer on the hydrophilic layer is removed to expose the image formation layer, and since the exposed hydrophilic layer contains the water-soluble phosphobetaine compound, the water-soluble phosphobetaine compound exists on the surface (non-image portion).

The phosphobetaine compound of the present invention will now be described.

The phosphobetaine compound of the present invention is a water-soluble compound containing a phosphonium anion and a quaternary ammonium cation in a molecule, and is, for example, represented by following Formula (1).

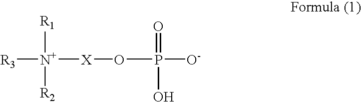

In Formula (1), R₁ and R₂ each represent a hydrogen atom or an alkyl group, R₃ represents a hydrocarbon group or an acyl group, and X represents an alkylene group having 1-3 carbon atoms. Water solubility in the present invention means that at least 0.1 g is dissolved in 100 g of water at 20° C.

The water-soluble phosphobetaine compound of the present invention is preferably a compound containing a group represented by foregoing Formula (2).

In Formula (2), each of R¹, R² and R³ represented by an alkyl group or a hydroxyalkyl group having 1-8 carbon atoms may be the same group or a different group, and can be a methyl group, an ethyl group, a propyl group, a butyl group, a pentyl group, a hexyl group, an isopropyl group, an isobutyl group, a hydroxyethyl group, a hydroxypropyl group, a hydroxybutyl group or a hydroxyhexyl group. Of these, a methyl group is preferable in view of procurement of material.

Specific examples of R⁴ include an ethylene group, a propylene group, a butylene group, a pentylene group, a hexylene group, an ethoxyleneethylene group, a propyleneoxypropylene group, a poly(ethyleneoxy)ethylene group, a poly(propyleneoxy)propylene group and so forth.

Specific examples of R⁵ include a methylene group, an ethylene group, a propylene group, a butylene group and so forth.

The water-soluble phosphobetaine compound of the present invention is preferably a polymer containing a group represented by foregoing Formula (2) in a side chain (hereinafter, referred to also as PC polymer).

The PC polymer, for example, can be prepared by homopolymerizing a monomer having a group represented in Formula (2) or copolymerizing with another polymer. The PC monomer may only have a polymerizable double bond and a group represented by foregoing Formula (2) in a molecule. As the monomer, a monomer represented by following Formula (3) is, for example, provided.

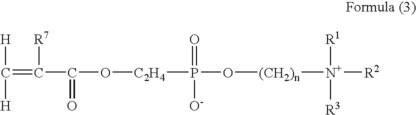

In Formula (3), each of R¹, R² and R³ is the same group or a different group, and represents an alkyl group or a hydroxyalkyl group having 1-8 carbon atoms. Further, R⁷ represents a hydrogen atom or a methyl group, and n is an integer of 2-4. Each of R¹, R² and R³ represented by an alkyl group having 1-8 carbon atoms may be the same group or a different group, and can be a methyl group, an ethyl group, a propyl group, a butyl group, a pentyl group, a hexyl group, an isopropyl group or an isobutyl group. Each of R¹, R² and R³ represented by a hydroxyethyl group may also be the same group or a different group, and can be a hydroxyethyl group, a hydroxypropyl group, a hydroxybutyl group or a hydroxyhexyl group. Of these, a methyl group is preferable in view of procurement of material.

Examples of monomers (PC monomers) represented by Formula (3) include 2-(meth)acryloyloxyethyl-2′-(trimethylammonio)ethylphosphate, 3-(meth)acryloyloxypropyl-2′-(trimethylammonio)ethylphosphate, 4-(meth)acryloyloxybutyl-2′-(trimethylammonio)ethylphosphate, 5-(meth)acryloyloxypentyl-2′-(trimethylammonio)ethylphosphate, 2-(meth)acryloyloxyethyl-2′-(triethylammonio)ethylphosphate, 3-(meth)acryloyloxypropyl-2′-(triethylammonio)ethylphosphate, 4-(meth)acryloyloxybutyl-2′-(triethylammonio)ethylphosphate, 5-(meth)acryloyloxypentyl-2′-(triethylammonio)ethylphosphate, 2-(meth)acryloyloxyethyl-2′-(tripropylammonio)ethylphosphate, 3-(meth)acryloyloxypropyl-2′-(tripropylammonio)ethylphosphate, 4-(meth)acryloyloxybutyl-2′-(tripropylammonio)ethylphosphate, 5-(meth)acryloyloxypentyl-2′-(tripropylammonio)ethylphosphate, 2(meth)acryloyloxyethyl-2′-(tributylammonio)ethylphosphate, 3-(meth)acryloyloxypropyl-2′-(tributylammonio)ethylphosphate, 4-(meth)acryloyloxybutyl-2′-(tripropylammonio)ethylphosphate, 5-(meth)acryloyloxypentyl-2′-(tributylammonio)ethylphosphate, 2-(meth)acryloyloxyethyl-3′-(trimethylammonio)propylphosphate, 2-(meth)acryloyloxyethyl-4′-(trimethylammonio)butylphosphate, 2-(meth)acryloyloxyethyl-3′-(triethylammonio) propylphosphate, 2-(meth)acryloyloxyethyl-4′-(triethylammonio) butylphosphate, 2-(meth)acryloyloxyethyl-3′-(tripropylammonio)propylphosphate, and 2-(meth)acryloyloxy ethyl 4′-(tripropylammonio)butylphosphate.

Further examples thereof include 2-(meth)acryloyloxyethyl-3′-(tributylammonio)propylphosphate, 2-(meth)acryloyloxyethyl-4′-(tributylammonio)butylphosphate, 3-(meth)acryloyloxypropyl-3′-(trimethylammonio)propylphosphate, 3-(meth)acryloyloxypropyl-4′-(trimethylammonio)butylphosphate, 3-(meth)acryloyloxypropyl-3′-(triethylammonio)propylphosphate, 3-(meth)acryloyloxypropyl-4′-(triethylammonio)butylphosphate, 3-(meth)acryloyloxypropyl-3′-(tripropylammonio)propylphosphate, 3-(meth)acryloyloxypropyl-4′-(tripropylammonio)butylphosphate, 3-(meth)acryloyloxypropyl-3′-(tributylammonio)propylphosphate, 3-(meth)acryloyloxypropyl-4′-(tributylammonio)butylphosphate, 4-(meth)acryloyloxybutyl-3′-(trimethylammonio)propylphosphate, 4-(meth)acryloyloxybutyl-4′-(trimethylammonio)butylphosphate, 4-(meth)acryloyloxybutyl-3′-(triethylammonio)propylphosphate, 4-(meth)acryloyloxybutyl-4′-(triethylammonio)butylphosphate, 4-(meth)acryloyloxybutyl-3′-(tripropylammonio)propylphosphate, 4-(meth)acryloyloxybutyl-4′-(tripropylammonio)butylphosphate, 4-(meth)acryloyloxybutyl-3′-(tributylammonio)propylphosphate, and 4-(meth)acryloyloxybutyl-4′-(tributylammonio)butylphosphate

Further provided can be derivatives of monomers such as maleic acid, fumaric acid and itaconic acid having one or two groups represented by Formula (2).

Of the foregoing PC monomers, a monomer represented by Formula (3) is preferable, but from further studies, 2-methacryloyloxyethyl-2′-(trimethylammonio)ethylphosphate (hereinafter, referred to also as MPC) is preferable, where R¹, R² and R³ are a methyl group, R7 is a methyl group, and n is 2, in view of procurement of material. MPC is represented by following Formula (4).

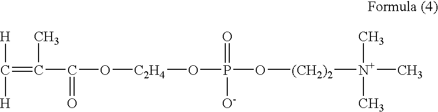

The foregoing PC monomer may be singly used for polymerization, or be used for polymerization by mixing at least two kinds.

Examples of other monomers copolymerized with a PC monomer include alkyl(meth)acrylate such as methyl(meth)acrylate, ethyl(meth)acrylate, n-butyl(meth)acrylate, 2-ethylhexyl(meth)acrylate, n-dodecyl(meth)acrylate, cyclohexyl(meth)acrylate, n-stearyl(meth)acrylate or isostearyl(meth)acrylate; silyl group-containing (meth)acrylate such as 3-{(meth)acryloyloxypropyl}trimethoxysilane, 3-{(meth)acryloyloxypropyl}triethoxysilane or 3-{(meth)acryloyloxypropyl}tripropyloxysilane; fluorine based (meth)acrylate such as 2-(perfluorooctyl)ethyl(meth)acrylate, 1H,1H,5H-octafluoropentyl(meth)acrylate, 1H,1H,7H-dodecafluoroheptyl(meth)acrylate or 2,2,2-trifluoro-1-trifluoromethylethyl(meth)acrylate; an amide based monomer such as 2-hydroxyethyl(meth)acrylate, 2-hydroxypropyl(meth)acrylate, polyethylene glycol mono(meth)acrylate, polypropyleneglycol mono(meth)acrylate, hydroxyl group-containing (meth)acrylate; (meth)acrylate amide or N,N-dimethyl(meth)acrylate amide; and (meth)acrylate. Further, examples of other monomers include a substituted or unsubstituted styrene based monomer such as styrene, methylstyrene or chloromethyl styrene; a vinyl ether based monomer such as ethylvinyl ether or butylvinyl ether; a vinyl ester based monomer such as vinyl acetate; a vinyl silane based monomer such as trimethoxyvinyl silane or triethoxyvinyl silane; a substituted or unsubstituted hydrocarbon based monomer such as ethylene, propylene, isobutylene, vinyl chloride or vinylidene chloride; a dibasic acid ester based monomer such as diethyl fumarate or diethyl malate; and N-vinyl pyrrolidone. Of these monomers, preferable are hydroxyl group-containing (meth)acrylate, alkyl(meth)acrylate, a styrene based monomer and a vinyl silane based monomer. More preferable is methacrylate ester containing an alkyl group or a hydroxyalkyl group having 4-18 carbon atoms.

Examples of PC polymers employed in the present invention include copolymers having a constituent of 2-(meth)acryloyloxy)ethyl-2′-(trimethylammonio)ethylphosphate which is a phospholipid-like monomer, such as a polymer of 2-((meth)acryloyloxyethyl)-2′-(trimethylammonio)ethylphosphate; a copolymer of 2-((meth)acryloyloxy)ethyl-2′-(trimethylammonio)ethylphosphate)-butyl(meth)acrylate; a copolymer of 2-((meth)acryloyloxy)ethyl-2′-(trimethylammonio)ethylphosphate-lauryl(meth)acrylate; a copolymer of 2-((meth)acryloyloxy)ethyl-2′-(trimethylammonio)ethylphosphate)-polypropylene glycol mono(meth)acrylate; a ternary copolymer of 2-((meth)acryloyloxy)ethyl-2′-(trimethylammonio)ethylphosphate-butylmethacrylate-2-hydroxyethyl methacrylate; a ternary copolymer of 2-(meth)acryloyloxy)ethyl-2′-(trimethylammonio)ethylphosphate-polypropylene glycol mono(meth)acrylate-(meth)acrylic acid.

When a water-soluble phosphobetaine compound is contained in an image formation layer, the water-soluble phosphobetaine compound having a content of 0.1-50% by weight is preferably contained in the image formation layer, and the water-soluble phosphobetaine compound having a content of 0.5-30% by weight is more preferably contained in the image formation layer.

A dry coating amount of the image formation layer is preferably within the range of 0.05-2 g/m², and more preferably within the range of 0.2-1 g/m².

The image formation layer of the present invention is formed on the after-described support via coating and drying. A preferably usable coating solvent employed for the image formation layer is singly water or a mixed solvent of water and an organic solvent. Preferable examples of water-miscible organic solvents include methanol, ethanol, isopropanol, 1,3-butanediol, 1,2,3-propanetriol, 2-phenoxyethanol and 3-butyleneglycol.

It is contemplated that the phosphobetaine compound of the present invention has a function in which, for example, a group represented by foregoing Formula (2) is adsorbed to the support surface. When an image formation layer coating solution containing a phosphobetaine compound of the present invention is coated on a support, a thin film of the phosphobetaine compound is considered to be formed on the interface between the support and the image formation layer, whereby it is contemplated that on-press developability at the non-image portion is improved since the thin film serves as a kind of a release layer. Thus, since this release layer is thermally stable, degradation of on-press developability is hardly observed even in the case of standing at roughly 40-60° C. for 24 hours to a couple of days.

When the phosphobetaine compound of the present invention is utilized, excellent on-press developability can be obtained even in the region where a content of the after-mentioned water-soluble compound to introduce on-press developability in an image formation layer is low. Since image formation is hardly inhibited by an oleophilic image formation material such as the after-mentioned thermoplastic particles, microcapsules, and polymerizable compounds, no degradation of sensitivity is substantially observed. As described above, since the content of the water-soluble compound in the image formation layer is possible to be reduced, a water-soluble component remaining in an image portion coated layer is reduced, whereby presumably, image intensity and water resistance are improved, and as a result, printing durability and resistance to chemicals are also improved.

The image formation layer of the present invention is a layer capable of forming the image portion and the non-image portion on a support by forming an image via print-making processes such as image exposure and a developing treatment, and as the image formation layer, provided is an image formation layer containing the after-mentioned thermoplastic particles (heat melting particles and heat fusible particles) or microcapsules encapsulating a hydrophobic material.

### (Thermoplastic Resin Particle)

The thermoplastic resin particles employed in the present invention are particles made of a thermoplastic resin, and preferably have an average particle diameter of 10-600 nm, more preferably have an average particle diameter of 20-300 nm, and most preferably have an average particle diameter of 40-150 nm.

The average particle diameter herein is a mean value from particle diameter values of 100 particles observed with a scanning electron microscope to determine the average particle diameter by averaging the major and minor axis diameters of a particle.

Plural kinds of thermoplastic resin particles having different average particle diameters within the above-described range are mixed and usable. In this case, they may be allowed to be the same kinds or the different kinds as the thermoplastic resin particles.

The thermoplastic resin particles are specifically provided below.

There provided heat melting particles and heat fusible particles as the thermoplastic resin particles of the present invention.

The heat melting particles are particularly particles having a low melt viscosity, which are particles formed from materials generally classified into wax. The materials preferably have a softening point of 40-120° C. and a melting point of 60-150° C., and more preferably a softening point 40-100° C. and a melting point of 60-120° C.

Materials usable include paraffin, polyolefin, polyethylene wax, microcrystalline wax, and fatty acid wax. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable.

Among them, polyethylene, microcrystalline wax, fatty acid ester and fatty acid are preferably contained. A high sensitive image formation can be performed since these materials each have a relative low melting point and a low melt viscosity.

The heat melting particles are preferably dispersible in water.

The composition of the heat melting particles may be continuously varied from the interior to the surface of the particles. The particles may be covered with a different material.

Known microcapsule production method or sol-gel method can be applied for covering the particles.

The heat fusible particles include thermoplastic polymer particles. Although there is no specific limitation to the upper limit of the softening point of the polymer particles, the softening point is preferably lower than the decomposition temperature of the polymer particles. The weight average molecular weight (Mw) of the thermoplastic hydrophobic polymer is preferably within the range of 10,000-1,000,000.

Examples of the polymer consisting the polymer particles include a diene (co)polymer such as polypropylene, polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl ester (co)polymer such as a polyvinyl acetate, a vinyl acetate-vinyl propionate copolymer and a vinyl acetate-ethylene copolymer, or a vinyl acetate-2-hexylethyl acrylate copolymer; and polyvinyl chloride, polyvinylidene chloride, polystyrene and a copolymer thereof. Among them, the (meth)acrylate polymer, the (meth)acrylic acid (co)polymer, the vinyl ester (co)polymer, the polystyrene and the synthetic rubbers are preferably used.

The heat fusible particles are preferably dispersible in water.

Further, the composition of the heat fusible particles may be continuously varied from the interior to the surface of the particles. The particles may be covered with a different material. As a covering method, known methods such as a microcapsule method and a sol-gel method are usable.

The content of thermoplastic resin particles in the image formation layer is 50-90% by weight, based on the image formation layer in view of on-press developability and printing durability, preferably 55-80% by weight, and more preferably 60-75% by weight.

Further, an image formation layer preferably contains a light-to-heat conversion material.

### (Light-to-Heat Conversion Material)

A light-to-heat conversion material of the present invention is a material capable of forming an image on an image formation layer by converting exposure light into heat. As the light-to-heat conversion material, there are the following dyes or pigments.

As dyes, examples of the infrared absorbing dye include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-to-heat conversion materials include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination.

Compounds described in Japanese Patent O.P.I. Publication Nos. 11-240270, 11-265062, 2000-309174, 2002-49147, 2001-162965, 2002-144750, and 2001-219667 can be preferably used.

Examples of the pigments include carbon, graphite, metal and metal oxide.

Furnace black and acetylene black is preferably used as the carbon. The graininess (d₅₀) thereof is preferably at most 100 nm, and more preferably at most 50 nm.

Particles having an average particle diameter of preferably at most 0.5 μm, more preferably at most 100 nm, and most preferably at most 50 nm are usable as the graphite.

As the metal, any metal can be used as long as the metal is in a form of fine particles having preferably an average particle diameter of at most 0.5 μm, more preferably at most 100 nm, and most preferably at most 50 nm. The metal may have any shape such as spherical, flaky and needle-like. Colloidal metal particles such as those of silver or gold are particularly preferred.

As the metal oxide, materials having black color in the visible regions or materials which are electrically conductive or semi-conductive can be used.

Examples of the former include black iron oxide and black complex metal oxides containing at least two metals.

Examples of the latter include Sb-doped SnO₂ (ATO), Sn-added In₂O₃ (ITO), TiO₂, TiO prepared by reducing TiO₂ (titanium oxide nitride, generally titanium black). Particles prepared by covering a core material such as BaSO₄, TiO₂, 9Al₂O₃.2B₂O and K₂O.nTiO₂ with these metal oxides is usable. These oxides are particles having an average particle diameter of at most 0.5 μm, preferably at most 100 nm, and more preferably at most 50 nm.

Among these light-to-heat conversion materials, black iron oxide or black complex metal oxides containing at least two metals are more preferred.

The black iron oxide (Fe₃O₄) particles have an average particle diameter of 0.01-1 μm, and an acicular ratio (major axis length/minor axis length) of preferably 1-1.5. It is preferred that the black iron oxide particles are substantially spherical ones (having an acicular ratio of 1) or octahedral ones (having an acicular ratio of around 1.4).

Examples of the black iron oxide particles include for example, TAROX series produced by Titan Kogyo K.K. Examples of the spherical particles include BL-100 (having a particle diameter of 0.2-0.6 μm), and BL-500 (having a particle diameter of 0.3-1.0 μm). Examples of the octahedral particles include ABL-203 (having a particle diameter of 0.4-0.5 μm), ABL-204 (having a particle diameter of 0.3-0.4 μm), ABL-205 (having a particle diameter of 0.2-0.3 μm), and ABL-207 (having a particle diameter of 0.2 μm)

The black iron oxide particles may be surface-coated with inorganic compounds such as SiO₂. Examples of such black iron oxide particles include spherical particles BL-200 (having a particle diameter of 0.2-0.3 μm) and octahedral particles ABL-207A (having a particle diameter of 0.2 μm), each having been surface-coated with SiO₂.

Examples of the black complex metal oxides containing at least two metals include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441.

The complex metal oxide of the present invention is preferably a Cu-Cr-Mn type complex metal oxide or a Cu—Fe—Mn type complex metal oxide. The Cu—Cr—Mn type complex metal oxides are preferably subjected to the treatment disclosed in Japanese Patent O.P.I. Publication Nos. 8-27393 in order to reduce isolation of a 6-valent chromium ion. These complex metal oxides provide high light heat conversion efficiency relative to the addition amount thereof in the photosensitive layer.

The average primary particle diameter of these complex metal oxides is preferably at most 1 μm, and more preferably 0.01-0.5 μm. The average primary particle diameter of at most 1 μm improves light heat conversion efficiency relative to the addition amount of the particles, and the average primary particle diameter of 0.01-0.5 μm further improves light heat conversion efficiency relative to the addition amount of the particles.

Light heat conversion efficiency to the addition amount of the particles is greatly influenced by degree of dispersion of the particles. The higher the degree of dispersion of the particles, the higher the light heat conversion efficiency. Accordingly, these complex metal oxide particles are preferably dispersed according to a known method to prepare a dispersion (paste), which is added to a coating solution.

When these complex metal oxide particles are dispersed, a dispersant can be used appropriately. The addition amount of the dispersant is preferably 0.01-5% by weight, and more preferably 0.1-2% by weight, based on the weight of complex metal oxide particles.

In the present invention, the content of light-to-heat conversion material is 1-20% by weight, based on the weight of an image formation layer, preferably 3-15% by weight, and more preferably 5-12% by weight.

A water-soluble compound such as oligomer, monomer, inorganic salt or organic salt other than a water-soluble phosphobetaine compound can be contained in an image formation layer. Additives such as a pH adjusting agent, a surfactant, a viscosity increasing agent and so forth can also be contained appropriately.

### (Water-Soluble Compound)

The water-soluble compound of the compound means a compound dissolving at least 0.1 g in 100 g of water at 25° C. , or a compound dissolving preferably at least 1 g in 100 g of water at 25° C. However, the foregoing water-soluble phosphate ester compound and the light-to-heat conversion material of the present invention are excluded from the water-soluble compound usable in the present invention.

The water-soluble compound in an image formation layer has a content of 1-40% by weight, preferably has a content of 5-30% by weight, and more preferably has a content of 10-25% by weight.

The following specific examples of water-soluble compounds can be provided, but the present invention is not limited thereto.

Examples of the water-soluble compounds include glycols such as ethylene glycol, diethylene glycol, triethylene glycol, propylene glycol, dipropylene glycol, tripropylene glycol, and ethers or ester derivatives thereof; polyhydroxys such as glycerin and pentaerythritol; organic amines such as triethanol amine, diethanol amine and monoethanol amine, and salts thereof; quarternary ammonium salts such as tetraethyl ammonium bromide and so forth; organic sulfonates such as toluene sulfonate and benzene sulfonate, and salts thereof; organic phosphonic acids such as phenylphosphonic acid and so forth, and salts thereof; organic carboxylic acids such as tartaric acid, oxalic acid, citric acid, malic acid, lactic acid, gluconic acid and amino acids, and salts thereof; phosphates such as trisodium phosphate, disodium hydrogen phosphate, sodium dihydrogen phosphate and guanidine phosphate; carbonates such as sodium carbonate and guanidine carbonate; others such as water-soluble organic or inorganic salts; and water-soluble polymers of saccharides (monosaccharide and oligosaccharide), polysaccharides, polyethylene oxide, polypropylen oxide, polyvinyl alcohol, polyethylene glycol (PEG), polyvinyl ether, polyacrylic acid, polyacrylate, polyacrylamide, polyvinyl pyrrolidone, polystyrene sulfonic acid or polystyrene sulfonate. Further, examples of the water-dispersible latex include styrene-butadiene copolymer latex, conjugated diene based polymer latex of a methyl methacrylate-butadiene copolymer, acrylic polymer latex and vinyl based polymer latex.

The following water-soluble polymerizable compounds can also be utilized.

Examples thereof include (meth)acrylonirile, (meth)acrylamide, (meth)acrylic acid, sodium(meth)acrylate, methyl(meth)acrylate, ethyl(meth)acrylate, n-propyl(meth)acrylate, isopropyl(meth)acrylate, n-butyl(meth)acrylate, isobutyl(meth)acrylate, t-butyl(meth)acrylate, 2-hydroxyethyl(meth)acrylate, 2-hydroxypropyl(meth)acrylate, 2-hydroxybutyl(meth)acrylate, dimethylaminoethyl(meth)acrylate, 2-cyanoethyl(meth)acrylate, β-ethoxyethylcellosolve(meth)acrylate, (meth)acrylaldehyde, N,N′-methylenebis(meth)acrylamide, 2-hexyloxyethyl-N-methacryloylcarbamate, allyl(meth)acrylate, acrylic acid-2-chloroethyl, 2,2-bis [4-(methacryloxy polyethoxy)phenyl]propane, acrylic acid diethylene glycol ethoxylate, polyethylene glycol di(meth)acrylate, 3-(meth)acryloylimino-1-phenyl-5-pyrazolone, ω-carboxy-polycaprolactone(n=2)monoacrylate, phthalic acid monohydroxyethyl(meth)acrylate, monohydroxyethyl succinate(meth)acrylate, acrylic acid dimer, 2-hydroxy-3-phenoxypropyl acrylate, isocyanuric ethyleneoxide (EO) modified diacrylate, pentaerythritol triacrylate, glycerol mono(meth)acrylate, glycerin(meth)acrylate, hydroxymethylvinyl ether, hydroxyethylvinyl ether, hydroxypropylvinyl ether and hydroxybutylvinyl ether.

Of these, salt compounds such as the above-described organic and inorganic salts are preferably usable as the water-soluble compound of the present invention. Specifically, a salt and a water-soluble compound are preferably used in combination.

The image formation layer of the present invention may contain a pH adjusting agent, a surfactant, a viscosity increasing agent and so forth, and may further contain a polymerization initiator. The polymerization initiator is preferably water-soluble or water-dispersible.

Examples of photopolymerization initiators include commonly known initiators such as (2-acryloyloxy)(4-benzoylbenzyl)dimethylammonium bromide, 2-(3-dimethylamino-2-hydroxypropoxy)-3,4-dimethyl-9H-thioxanthone-9-on mesochloride, (4-benzoylbenzyl)Chlorinated trimethyl ammonium, 2 (2′-trimethylammonium ethylamino)-4 and 6-bis(tri chloromethyl)-S-triazine. The commonly known polymerization initiators having an organic solvent solubility may only be used as a water dispersion for the water-dispersive polymerization initiator with an oil protecting dispersion method.

When the image formation layer contains a water-soluble phosphobetaine compound, and there are at least 2 image formation layers, an image formation layer right next to a support contains the water-soluble phosphobetaine compound. In order to obtain a planographic printing plate material comprising a water-soluble phosphobetaine compound between a support and an image formation layer, there is disclosed another mode such that the support of the planographic printing plate material comprises a hydrophilic layer (subbing layer) containing the water-soluble phosphobetaine compound on the image formation layer side of the support. The hydrophilic layer containing the water-soluble phosphobetaine compound may be a layer containing only a water-soluble phosphobetaine compound, or a layer containing binder and so forth.

The above-described similar effect can be produced even in the case of a mode where a hydrophilic layer (subbing layer) containing a phosphobetaine compound of the present invention is formed.

In the case of the phosphobetaine compound being used singly, a dry coating amount of the phosphobetaine compound is preferably 1-50 mg/m² based on the hydrophilic layer (subbing layer), and more preferably 5-30 mg/m²

The above-described water-soluble compound and inorganic binder can further be contained in the hydrophilic layer (subbing layer). In this case, a dry coating amount of the hydrophilic layer is preferably 0.1-10 g/m², and more preferably 0.5-5 g/m².

Of the above-described water-soluble compounds, a water-soluble polymer such as polyvinyl alcohol, polyethylene glycol (PEG), polyvinyl ether, polyacrylic acid, polyacrylate, polyacrylamide, polyvinyl pyrrolidone, polystyrene sulfonic acid or polystyrene sulfonate acts also as a binder. A metal oxide is preferably usable as an inorganic binder. The metal oxide is preferably metal oxide particles.

Examples of the metal oxide particles include colloidal silica particles, an alumina sol, a titania sol and another metal oxide sol. The metal oxide particles may have any shape such as spherical, needle-like, and feather-like shape. The average particle size is preferably 3-100 nm, and plural kinds of metal oxide each having a different size may be used in combination. The surface of the particles may also be subjected to surface treatment.

The metal oxide particles can be used as a binder, utilizing its layer forming ability. The metal oxide particles are suitably used in a hydrophilic layer since they minimize lowering of the hydrophilicity of the layer as compared with an organic compound binder. Among the above-mentioned, colloidal silica is particularly preferred in the present invention. The colloidal silica has a high layer forming ability under a drying condition with a relative low temperature, and can provide a high layer strength even for a layer in which a material containing no carbon atom occupies at least 91% by weight. It is preferred that the colloidal silica is necklace-shaped colloidal silica or colloidal silica particles having an average particle diameter of at most 20 nm. Further, it is preferred that the colloidal silica provides an alkaline colloidal silica solution as a colloid solution.

The necklace-shaped colloidal silica of the present invention is a generic term of an aqueous dispersion system of spherical silica having a primary particle diameter of the order of nm. The necklace-shaped colloidal silica to be used in the present invention means a “pearl necklace-shaped” colloidal silica formed by connecting spherical colloidal silica particles each having a primary particle diameter of 10-50 μm so as to attain a length of 50-400 nm. The term of “pearl necklace-shaped” means that the image of connected colloidal silica particles is like to the shape of a pearl necklace. The bonding between the silica particles forming the necklace-shaped colloidal silica is considered to be —Si—O—Si—, which is formed by dehydration of —SiOH groups located on the surface of the silica particles. Concrete examples of the necklace-shaped colloidal silica include Snowtex-PS series produced by Nissan Chemical Industries, Ltd.

As the products, there are Snowtex-PS-S (the average particle diameter in the connected state is approximately 110 nm), Snowtex-PS-M (the average particle diameter in the connected state is approximately 120 nm) and Snowtex-PS-L (the average particle diameter in the connected state is approximately 170 nm). Acidic colloidal silicas corresponding to each of the above-mentioned are Snowtex-PS-S-O, Snowtex-PS-M-O and Snowtex-PS-L-O, respectively. The necklace-shaped colloidal silica is preferably used in a hydrophilic layer as a porosity providing material for hydrophilic matrix phase, and porosity and strength of the layer can be secured by its addition to the layer.

Among them, the use of Snowtex-PS-S, Snowtex-PS-M or Snowtex-PS-L, each being alkaline colloidal silica particles, is particularly preferable since the strength of the hydrophilic layer is increased and occurrence of background contamination is inhibited even when a lot of prints are printed.

It is known that the binding force of the colloidal silica particles is become larger with decrease of the particle size. The average particle size of the colloidal silica particles to be used in the invention is preferably not more than 20 nm, and more preferably 3-15 nm. As above-mentioned, the alkaline colloidal silica particles show the effect of inhibiting occurrence of the background contamination. Accordingly, the use of the alkaline colloidal silica particles is particularly preferable.

Examples of the alkaline colloidal silica particles having the average particle diameter within the foregoing range include Snowtex-20 (particle diameter: 10-20 nm), Snowtex-30 (particle diameter: 10-20 nm), Snowtex-40 (particle diameter: 10-20 nm), Snowtex-N (particle diameter: 10-20 nm), Snowtex-S (particle diameter: 8-11 nm) and Snowtex-XS (average particle diameter: 4-6 nm), each produced by Nissan Chemical Industries, Ltd. The colloidal silica particles having an average particle diameter of at most 20 nm, when used together with the necklace-shaped colloidal silica as described above, is particularly preferred, since appropriate porosity of the layer is maintained and the layer strength is further increased. The ratio of the colloidal silica particles having an average particle diameter of at most 20 nm to the necklace-shaped colloidal silica is preferably 95/5-5/95, more preferably 70/30-20/80, and most preferably 60/40-30/70.

An aqueous silicate solution is also usable as another additive to the hydrophilic layer in the present invention. An alkali metal silicate such as sodium silicate, potassium silicate or lithium silicate is preferable, and the SiO₂/M₂O is preferably selected in such a way that the pH value of the coating liquid after addition of the silicate does not exceed 13 in order to prevent dissolution of inorganic particles. An inorganic polymer or an inorganic-organic hybrid polymer prepared by a sol-gel method employing a metal alkoxide. Known methods described in S. Sakka “Application of Sol-Gel Method” (published by Agne shoufuu sha) or in the publications cited in the above publication can be applied to prepare the inorganic polymer or the inorganic-organic hybridpolymer by the sol-gel method.

Of the above-described, colloidal silica and silicate are preferably usable. The hydrophilic layer may also contain a hydrophilic organic resin. Examples of the hydrophilic organic resin include polysaccharides such as starches, celluloses, polyuronic acid and pullulan, polyethylene oxide, polypropylene oxide, polyvinyl alcohol, polyethylene glycol (PEG), polyvinyl ether, a styrene-butadiene copolymer, a conjugated diene polymer latex of methyl methacrylate-butadiene copolymer, an acrylic polymer latex, a vinyl based polymer latex, polyacrylamide, and polyvinyl pyrrolidone.

A light-to-heat conversion material may also be contained. Examples of the usable light-to-heat conversion material include a commonly known infrared absorbing dye, carbon black, graphite, black metal oxide pigment, and so forth. Examples of the material capable of containing in a hydrophilic layer include materials employed for hydrophilic layers specifically described in Japanese Patent O.P.I. Publication No. 2002-37046, Japanese Patent O.P.I. Publication No. 2003-23137, Japanese Patent O.P.I. Publication No. 2004-29142 and Japanese Patent O.P.I. Publication No. 2005-88330.

When the hydrophilic layer contains binder and so forth, a content of a phosphobetaine compound in the hydrophilic layer is preferably 0.01-5% by weight, and more preferably 0.1-3% by weight. In the case of the content of less than 0.0% by weight, the effect tends to be insufficient, and in the case of the content exceeding 5% by weight, water resistance of the hydrophilic layer tends to be degraded.

The hydrophilic layer (subbing layer) can be obtained by coating a subbing layer coating solution containing the above-described component. Examples of the coating solvent usable for a hydrophilic layer (subbing layer) coating solution include water, alcohol and others such as water-miscible organic solvents. As a method to exhibit hydrophilicity, also provided is a dipping treatment in which a substrate is simply immersed in a solution containing a water-soluble phosphobetaine compound and pulled out of it. In this case, a content of the water-soluble phosphobetaine compound in the solution containing the water-soluble phosphobetaine compound is preferably 0.01-5% by weight, and more preferably 0.1-2% by weight. The pH of the solution containing the water-soluble phosphobetaine compound is preferably 3-12, and more preferably 4-10. Temperature applied during immersion is preferably 20-95° C., and more preferably 30-80° C. The immersing time is preferably 1-120 seconds. Further, after immersion, a washing treatment and a drying treatment are preferably conducted.

### (Support)

The support of the present invention is a substrate comprising a substrate surface on which portions exposed by removing an image formation layer via print-making are capable of being water-receptive non-image portions, comprising a hydrophilic surface layer obtained via a hydrophilic treatment of a substrate surface, and comprising a hydrophilic layer containing a hydrophilic material.

As a support of the present invention, a commonly known material employed as a substrate for a printing plate is usable. For example, provided are paper sheets treated with a metal plate, a plastic film, polyolefin and so forth, and composite substrates multilayered with the foregoing materials.

Thickness of the support is not particularly limited provided that the support is installable in a printing press, but a support thickness of 50-500 μm is easy to be handled.

As the support of the present invention, a metal plate having the support surface which was subjected to a hydrophilic treatment is preferably usable.

Examples of the metal plate include plates made of iron, stainless, aluminum and so forth, but according to the present invention, an aluminum plate and an aluminum alloy plate (hereinafter, they both are called an aluminum plate) are preferable in view of a relationship between specific gravity and stiffness. In addition, aluminum plates which have been subjected to any one of a surface roughening treatment, an anodization treatment and a surface hydrophilic treatment (so-called grained aluminum plates) are more preferable.

Various kinds of aluminum alloys are usable as substrates, and examples thereof include alloys of Al in combination with Si, Cu, Mn, Mg, Cr, Zn, Pb, Bi, Ni, Ti, Na or Fe.

It is preferable that the aluminum plate employed as a substrate is subjected to degreasing treatment for removing rolling oil prior to surface roughening (graining). The degreasing treatments include degreasing treatment, which employs solvents such as trichlene and thinner, and an emulsion degreasing treatment, which employs an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution such as caustic soda is used for the degreasing treatment, the resulting substrate is preferably subjected to desmut treatment in an aqueous solution of an acid such as phosphoric acid, nitric acid, sulfuric acid, chromic acid, or a mixture thereof, since smut is produced on the surface of the substrate. The surface roughening methods include a mechanical surface roughening method and an electrolytic surface roughening method electrolytically etching the substrate surface.

Though there is no restriction for the mechanical surface roughening method, a brushing roughening method and a honing roughening method are preferable. The brushing roughening method is carried out by rubbing the surface of the substrate with a rotating brush with a brush hair with a diameter of 0.2-0.8 mm, while supplying slurry in which volcanic ash particles with a particle diameter of 10-100 μm are dispersed in water to the surface of the substrate. The honing roughening method is carried out by ejecting obliquely slurry with pressure applied from nozzles to the surface of the substrate, the slurry containing volcanic ash particles with a particle diameter of 10-100 μm dispersed in water. A surface roughening can be also carried out by laminating a substrate surface with a sheet on the surface of which abrading particles with a particle diameter of 10-100 μm was coated at intervals of 100-200 μm and at a density of 2.5×10³-10×10³/cm², and applying pressure to the sheet to transfer the roughened pattern of the sheet and roughen the surface of the substrate.

After the substrate has been roughened mechanically, it is preferably dipped in an acid or an aqueous alkali solution in order to remove abrasives and aluminum dust, etc. which have been embedded in the surface of the substrate. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous alkali solution of for example, sodium hydroxide is preferably used. The dissolution amount of aluminum in the substrate surface is preferably 0.5-5 g/m². After the substrate has been dipped in the aqueous alkali solution, it is preferable for the substrate to be dipped in an acid such as phosphoric acid, nitric acid, sulfuric acid and chromic acid, or in a mixed acid thereof, for neutralization.

Though there is no restriction for the electrolytic surface roughening method, a method, in which the substrate is electrolytically surface roughened in an acidic electrolytic solution, is preferred. Though an acidic electrolytic solution generally used for the electrolytic surface roughening can be used, it is preferable to use an electrolytic solution of hydrochloric acid or that of nitric acid. The electrolytic surface roughening method disclosed in Japanese Patent Examined Publication No. 48-28123, British Patent No. 896,563 and Japanese Patent O.P.I. Publication No. 53-67507 can be used. In the electrolytic surface roughening method, voltage applied is generally 1-50 V, and preferably 10-30 V. The current density used can be selected from the range of 10-200 A/dm², and is preferably 50-150 A/dm². The quantity of electricity can be selected from the range of 100-5000 C/dm², and is preferably 100-2000 C/dm². The temperature during the electrolytically surface roughening may be in the range of 10-50° C., and is preferably 15-45° C.

When the substrate is electrolytically surface roughened by using an electrolytic solution of nitric acid, voltage applied is generally 1-50 V, and preferably 5-30 V. The current density used can be selected from the range of 10-200 A/dm², and is preferably 20-100 A/dm². The quantity of electricity can be selected from the range of 100-5000 C/dm², and is preferably 100-2000 C/dm². The temperature during the electrolytically surface roughening may be in the range of 10-50° C., and is preferably 15-45° C. The nitric acid concentration in the electrolytic solution is preferably 0.1-5% by weight. It is possible to optionally add, to the electrolytic solution, nitrates, chlorides, amines, aldehydes, phosphoric acid, chromic acid, boric acid, acetic acid or oxalic acid.

When the substrate is electrolytically surface roughened by using an electrolytic solution of hydrochloric acid, voltage applied is generally 1-50 V, and preferably 2-30 V. The current density can be selected from the range of 10-200 A/dm², and is preferably 50-150 A/dm². The quantity of electricity can be selected from the range of 100-5000 C/dm², and is preferably 100-2000 C/dm². The temperature during the electrolytically surface roughening may be in the range of 10-50° C., and is preferably 15-45° C. The hydrochloric acid concentration in the electrolytic solution is preferably 0.1-5% by weight.

After the substrate has been electrolytically surface roughened, it is preferably dipped in an acid or an aqueous alkali solution in order to remove aluminum dust, etc. produced in the surface of the substrate. Examples of the acid include sulfuric acid, persulfuric acid, hydrofluoric acid, phosphoric acid, nitric acid and hydrochloric acid, and examples of the alkali include sodium hydroxide and potassium hydroxide.

Among those mentioned above, the aqueous alkali solution is preferably used. The dissolution amount of aluminum in the substrate surface is preferably 0.5-5 g/m². After the support has been dipped in the aqueous alkali solution, it is preferable for the support to be dipped in an acid such as phosphoric acid, nitric acid, sulfuric acid and chromic acid, or in a mixed acid thereof, for neutralization.

The mechanical surface roughening and electrolytic surface roughening may be carried out singly, and the mechanical surface roughening followed by the electrolytic surface roughening may be carried out.

After the surface roughening, anodizing treatment may be carried out. There is no restriction in particular for the method of anodizing treatment used in the present invention, and known methods can be used. The anodizing treatment forms an anodization film on the surface of the substrate. For the anodizing treatment there is preferably used a method of applying a current density of 1-10 A/dm² to an aqueous solution containing sulfuric acid and/or phosphoric acid in a concentration of 10-50%, as an electrolytic solution. However, it is also possible to use a method of applying a high current density to sulfuric acid as described in U.S. Pat. No. 1,412,768, a method to electrolytically etching the support in phosphoric acid as described in U.S. Pat. No. 3,511,661, or a method of employing a solution containing two or more kinds of chromic acid, oxalic acid, malonic acid, etc. The coated amount of the formed anodization film is suitably 1-50 mg/dm², and preferably 10-40 mg/dm². The coated amount of the formed anodization film can be obtained from the weight difference between the aluminum plates before and after dissolution of the anodization film. The anodization film of the aluminum plate is dissolved employing for example, an aqueous phosphoric acid chromic acid solution which is prepared by dissolving 35 ml of 85% by weight phosphoric acid and 20 g of chromium (IV) oxide in 1 liter of water.

The substrate, which has been subjected to anodizing treatment, is optionally subjected to sealing treatment. For the sealing treatment, it is possible to use known methods using hot water, boiling water, steam, a sodium silicate solution, an aqueous dichromate solution, a nitrite solution and an ammonium acetate solution.

After the above treatment, the support is suitably undercoated as a hydrophilization treatment with a water soluble resin such as polyvinyl phosphonic acid, a polymer or copolymer having a sulfonic acid in the side chain, or polyacrylic acid; a water soluble metal salt such as zinc borate; a yellow dye; an amine salt; and so on. The sol-gel treatment support disclosed in Japanese Patent O.P.I. Publication No. 5-304358, which has a functional group capable of causing addition reaction by radicals as a covalent bond, is suitably used.

Examples of plastic films used as substrates include films composed of polyethylene terephthalate, polyethylene naphthalate, polyimide, polyamide, polycarbonate, polysulfone, polyphenylene oxide, cellulose esters and so forth.

The planographic printing plate material of the present invention is subjected to print-making processes such as imagewise exposure, a development treatment and so forth to obtain a planographic printing plate of the present invention. The development treatment is conducted by a method employing a developer, or by an on-press-development method of supplying dampening water or printing ink on a printing press, but in the present invention, a development treatment via the on-press-development method is specifically effective for a planographic printing plate material.

### (Imagewise Exposure)

The planographic printing plate material is preferably imagewise exposed to laser light to form an image.

In this case, it is preferable that exposure to a thermal laser is especially conducted to form the image.

The exposure is preferably scanning exposure, which is carried out employing a laser, which can emit light having a wavelength of infrared and/or near-infrared regions, that is, a wavelength of 700-1500 nm.

As the laser, a gas laser can be used, but a semi-conductor laser, which emits light having a near-infrared region wavelength, is preferably used.

A device suitable for the scanning exposure in the present invention may be any device capable of forming an image on the printing plate material according to image signals from a computer employing a semi-conductor laser.

Generally, the following scanning exposure processes are mentioned.

(1) A process in which a plate precursor provided on a fixed horizontal plate is scanning exposed in two dimensions, employing one or several laser beams.

(2) A process in which the surface of a plate precursor provided along the inner peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

(3) A process in which the surface of a plate precursor provided along the outer peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder. Process (3) is employed especially when a printing plate material mounted on a plate cylinder of a printing press is scanning exposed.

### (Printing)

Planographic printing of the present invention is conducted by supplying a dampening water and printing ink employing a planographic printing plate of the present invention. The dampening water and printing ink conventionally employed for planographic printing are usable.

It is preferred that the dampening solution contains no isopropanol or contains isopropanol in an amount of at most 0.5% by weight based on the weight of water.

The planographic printing plate material is imagewise exposed to infrared laser light, and developed on a printing press by supplying a dampening water or both of dampening water and printing ink to conduct on-press-development. The planographic printing method of the present invention is preferable as a printing method.

After the planographic printing plate material is imagewise exposed and mounted on a plate cylinder of a printing press, or after the planographic printing plate material is mounted on the cylinder and then imagewise heated to obtain a printing plate material, a dampening water supply roller and/or an ink supply roller are brought into contact with the surface of the resulting printing plate material while rotating the plate cylinder to remove non-image portions of the image formation layer of the printing plate material.

Removal of the non-image portions concerning a so-called on-press developing process will be described below.

Removal (on-press development) of the non-image portions (unexposed portions) of the image formation layer of a printing plate material mounted on the plate cylinder, can be carried out by bringing a dampening roller and an inking roller into contact with the image formation layer while rotating the plate cylinder. On-press development can be carried out, for example by various sequences as described below or another appropriate sequence.

The supplied amount of dampening solution may be adjusted to be greater or smaller than the amount ordinarily supplied in printing, and the adjustment may be carried out stepwise or continuously.

Sequence (1) A dampening roller is brought into contact with the image formation layer of a printing plate material on the plate cylinder during one to several tens of rotations of the plate cylinder, and then an inking roller brought into contact with the image formation layer during the next one to tens of rotations of the plate cylinder. Thereafter, printing is carried out.

Sequence (2) An inking roller is brought into contact with the image formation layer of a printing plate material on the plate cylinder during one to several tens of rotations of the plate cylinder, and then a dampening roller brought into contact with the image formation layer during the next one to tens of rotations of the plate cylinder. Thereafter, printing is carried out.

Sequence (3) An inking roller and a dampening roller are brought into contact with the image formation layer of a printing plate material on the plate cylinder during one to several tens of rotations of the plate cylinder. Thereafter, printing starts.

As another mode to produce a planographic printing plate of the present invention, a method in which a water-soluble phosphobetaine compound of the present invention is supplied to non-image portions after preparation of image portions and non-image portions will be described.

As a mode, provided is a method in which a water-soluble phosphobetaine compound of the present invention is supplied to non-image portions after a printing plate material having an image formation layer provided on a support is imagewise exposed to light with a commonly known method, and the image formation layer corresponding to non-image portions is removed via a developing treatment to prepare image portions and non-image portions. In this case, the water-soluble phosphobetaine compound is allowed to be supplied on the entire printing plate rather than non-image portions only.

A commonly known positive type or negative type image formation layer is usable as an image formation layer.

A method of supplying a water-soluble phosphobetaine compound is not particularly limited, but coater-coating, dip-coating, spraying, ink-jet and so forth are preferable. Also preferable is a method of filling a gum liquid supplying portion in an automatic developing machine with a processing liquid containing a water-soluble phosphobetaine compound to be supplied to a printing plate, employing the automatic developing machine commonly usable for development of a printing plate.

An amount of the water-soluble phosphobetaine compound existing in non-image portions of a printing plate of the present invention per area of the non-image portions is preferably 1-50 mg/m², and more preferably 5-30 mg/m².

Further, there is another method in which a water-soluble phosphobetaine compound of the present invention is supplied to non-image portions after image portions and non-image portions are prepared by imagewise providing an oleophilic image portion forming material to the substrate surface which is a surface serving as non-image portions of a printing plate.

Examples of the method of preparing image portions by imagewise providing an image portion forming material include a thermal transfer method and an ink-jet method. Preferably provided is the specific image portion forming method employing radiation-curable type ink described in Japanese Patent O.P.I. Publication No. 2003-211651, Japanese Patent O.P.I. Publication No. 2003-245818, Japanese Patent O.P.I. Publication No. 2004-2616, Japanese Patent O.P.I. Publication No. 2006-8880, Japanese Patent O.P.I. Publication No. 2006-117795 and Japanese Patent O.P.I. Publication No. 2006-137876. Further, preferably usable is aqueous radiation-curable type ink described in Japanese Patent O.P.I. Publication No. 3-216379, Japanese Patent O.P.I. Publication No. 2000-186242, Japanese Patent O.P.I. Publication No. 2000-186243, Japanese Patent O.P.I. Publication No. 5-186725, Japanese Patent O.P.I. Publication No. 2000-336295, WO2006/80139, EP1702961, Japanese Patent O.P.I. Publication No. 2006-249123 and Japanese Patent O.P.I. Publication No. 2006-249216. The method of supplying a water-soluble phosphobetaine compound can be conducted in the same manner as in the above-described mode.

### EXAMPLE

Next, the present invention will now be described in detail referring to examples, but the present invention is not limited thereto. Incidentally, “parts” and “%” in the examples represent parts by weight” and “% by weight”, respectively, unless otherwise specifically specified.

### Example 1

### [Support 1]

A 0.24 mm thick aluminum plate (material 1050, refining H16) was immersed in an aqueous 1% by weight sodium hydroxide solution at 50° C. to give an aluminum dissolution amount of 2 g/m², washed with water, immersed in an aqueous 5% by weight nitric acid solution at 25° C. for 30 seconds to neutralize, and then washed with water.

Subsequently, the aluminum plate was subjected to an electrolytic surface-roughening treatment in an electrolytic solution containing 11 g/liter of hydrochloric acid, 10 g/liter of acetic acid and 8 g/liter of aluminum at a peak current density of 80 A/dm² employing an alternating current with a sine waveform, in which the distance between the plate surface and the electrode was 10 mm. The electrolytic surface-roughening treatment was divided into 8 treatments, in which the quantity of electricity used in one treatment (at a positive polarity) was 40 C/dm², and the total quantity of electricity used (at a positive polarity) was 320 C/dm². Standby time of 3 seconds, during which no surface-roughening treatment was carried out, was provided after each of the separate electrolytic surface-roughening treatments.

Subsequently, the resulting aluminum plate was immersed in an aqueous 10% by weight phosphoric acid solution at 50° C. and etched to give an aluminum etching amount (including smut produced on the surface) of 0.65 g/m², and washed with water. Subsequently, the aluminum plate was subjected to anodizing treatment in an aqueous 20% by weight sulfuric acid solution at a current density of 5 A/dm² to form an anodization film having a coating amount of 2.5 g/m², and washed with water.

The washed surface of the plate was squeegeed, and the plate was immersed in an aqueous 0.5% by weight disodium hydrogenphosphate solution maintained at 70° C. for 15 seconds, washed with water, and dried at 80° C. for 5 minutes to obtain Support 1.

As to the surface roughness of the support, the Ra value as a surface roughness parameter of the support was measured according to the following method. Surface roughness Ra of Support 1 was 0.27 μm.

### (Measurement of Surface Roughness Parameter)

A platinum-rhodium layer with a thickness of 1.5 nm are vacuum-deposited onto a sample surface, and surface roughness is measured under the condition of a magnification of 40 times, employing a non-contact three dimensional surface roughness measuring device RST plus produced by WYKO Co., Ltd., (in which the measurement area is 111.2 μm×149.7 μm, the measuring point is 236×368, and the resolution is approximately 0.5 μm). The resulting measurement is subjected to slope correction and to filtering treatment of Median Smoothing to obtain surface roughness Ra after removing noise. Five portions are measured, and the average of the measurements is taken to determine surface roughness Ra.

### [Support 2]

The following subbing layer coating solution A was coated on the surface of Support 1 employing a wire bar so as to give a dry coating amount of 20 mg/m², and dried at 100° C. for one minute to obtain Support 2 comprising a subbing layer.

(Subbing layer coating solution A)

| | |
|---|---|
| Following phosphobetaine compound [1] | 0.30 parts by weight |
| Pure water | 99.70 parts by weight |

Phosphobetaine compound [1]

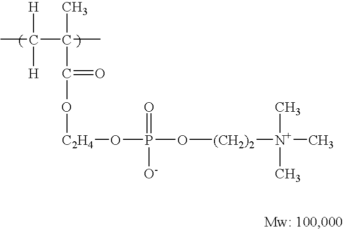

### [Support 3]

The following subbing layer coating solution B was coated on the surface of Support 1 employing a wire bar so as to give a dry coating amount of 15 mg/m², and dried at 100° C. for one minute to obtain Support 3 comprising a subbing layer.

(Subbing layer coating solution B)

| | |
|---|---|
| Following phosphobetaine compound [2] | 0.15 parts by weight |
| Pure water | 99.85 parts by weight |

Phosphobetaine compound [2]

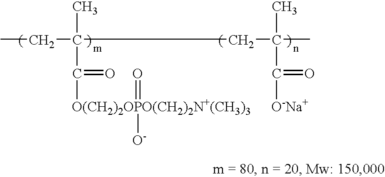

### [Preparation of Image Formation Layer Coating Solution]

Each material (parts by weight) as shown in the following Table 1 was sufficiently mixed while stirring, and filtered to obtain each of image formation layer coating solutions 1-6 having a solid content of 5% by weight. Sequentially, pure water was first added into an aqueous dispersion of thermoplastic resin particles, and an aqueous solution of a water-soluble resin (compound) was subsequently dripped and mixed while stirring. The aqueous solution was dripped and mixed in the case of containing a water-soluble phosphobetaine compound, and subsequently additives were introduced and mixed in the case of containing other additives. Then, an aqueous solution of a cyanine dye as a light-to-heat conversion material was dripped and mixed.

TABLE 1

| | | 1 | 2 | 3 | 4 | 5 | 6 |
|---|---|---|---|---|---|---|---|
| Material | | % by weight | | | | | |
| Ther- | Styrene acryl | 8.75 | 9.13 | 9.38 | 9.63 | 9.38 | 7.50 |
| mo- | particle dispersion | | | | | | |
| plastic | An average particle | | | | | | |
| resin | diameter | | | | | | |
| particle | Of 80 nm, | | | | | | |
| | Tg = 100° C. | | | | | | |
| | a solid content | | | | | | |
| | of 40% by wight, | | | | | | |
| | pH 8, and solvent | | | | | | |
| | composition: | | | | | | |
| | water/IPA = 90/10 | | | | | | |
| Light- | Aqueous solution of | 50.00 | 60.00 | 50.00 | 40.00 | 50.00 | 50.00 |
| to-heat | cyanine dye (shown | | | | | | |
| conver- | below) | | | | | | |
| sion | A solid content of | | | | | | |
| material | 1% by weight | | | | | | |
| Water- | Aqueous mixture | 6.50 | | | | 7.50 | 15.00 |
| soluble | solution of | | | | | | |
| resin | polyacrylic acid | | | | | | |
| | (Mw: 2,500,000) | | | | | | |
| | and trisodium | | | | | | |
| | phosphate · | | | | | | |
| | 12-water | | | | | | |
| | Weight ratio of the | | | | | | |
| | mixture: 20/80 | | | | | | |
| | and a solid content | | | | | | |
| | of 10% by weight | | | | | | |
| | Aqueous sodium | | 0.83 | | 0.50 | | |
| | polyacrylate | | | | | | |
| | solution | | | | | | |
| | Mw: 170,000 and | | | | | | |
| | a solid content of | | | | | | |
| | 30% by weight | | | | | | |
| Water- | Water-soluble | 7.00 | | | 12.00 | | |
| soluble | phosphobetaine | | | | | | |
| phos- | compound [1] | | | | | | |
| pho- | Aqueous solution | | | | | | |
| betaine | of 5% by weight | | | | | | |
| com- | Water-soluble | | 10.00 | 15.00 | | | |
| pound | phosphobetaine | | | | | | |
| | compound [2] | | | | | | |
| | Aqueous solution | | | | | | |
| | of 5% by weight | | | | | | |
| | Pure water | 27.75 | 20.04 | 25.62 | 37.87 | 33.12 | 27.50 |

Cyanine dye

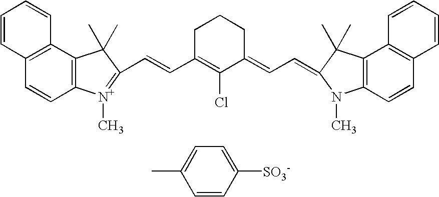

### [Preparation of Printing Plate Material]

Employing the combination provided in Table 2, each of image formation layer coating solutions 1-6 was coated on each support so as to give a dry coating amount of 0.5 g/m² employing a wire bar, and dried at 55° C. for 3 minutes. Next, an aging treatment was conducted at 40° C. for 24 hours to obtain each of printing plate material samples 1-9 in Table 2.

Each of the printing plate material samples obtained above was divided into two kinds of samples for the following evaluation, one was evaluated immediately after aging, and the other was evaluated further after conducting a heat-storing treatment at 55° C. for 48 hours.

### <Exposure Employing Infrared Laser>

Each of the printing plate material samples was mounted on an exposure drum, and imagewise exposed. The exposure was carried out employing an infrared laser (having a wavelength of 830 nm and a beam spot diameter of approximately 18 μm) at a resolution of 2400 dpi (“dpi” herein shows the number of dots per 2.54 cm) and at a screen line number of 175 to form an image. The image pattern used for exposure had a solid image, and a dot image with a dot area of 1-99%. Exposure energy was 300 mJ/cm².

Printing was carried out employing a printing press, DAIYA 1F-1 produced by Mitsubishi Heavy Industries, Ltd, and employing coated paper, a dampening water, a 2% by weight solution of Astromark 3 (produced by Nikken Kagaku Kenkyusyo Co., Ltd.), and printing ink (TK Hyunity MZ Magenta, produced by Toyo Ink Manufacturing Co., Ltd.).

The exposed sample was mounted on a plate cylinder of a printing press, and printing was carried out in the same printing condition and printing sequence as a conventional PS plate to obtain 500 prints.

Next, printing was carried out in the same manner as above until 20,000 prints were obtained, except that coated paper was replaced by fine-quality paper (Shiorai).

### [On-Press Developability]

The number of prints printed from the beginning of printing until a print with good image was obtained was determined. Herein, good image means an image in which a 90% dot area is reproduced, a solid image has a density of at least 1.5, and stains are not found at the background. When a print with good image was not obtained in the case of printing of 500 coated paper sheets, the decision was made as at least 500.

### [Evaluation of Printing Durability]

The printed image was observed in every 1000th print to check an image deterioration level of a 3% dot image portion and a solid image portion. One observed when uneven image density was visually observed at the solid image portion, or when lack of dots at the 3% dot image was observed was set to a printing durability end-point, and the number of prints was determined as the number of printing durability. When no lack of dots at the 3% dot image and no uneven image density at the solid image portion were observed after printing 20,000 sheets, the decision was made as at least 20,000.

### (Evaluation of Resistance to Chemicals)

Similarly to the above, 500 coated paper sheets were printed. A cleaner was evenly coated onto a printing plate after printing with a sponge impregnated with Ultra Plate Cleaner (produced by SK Liquid Production Co.). After standing in this situation for 2 minutes, the cleaner on the printing plate was wiped with a sponge out of which water has been screwed. Next, 100 more paper sheets were further printed, and the 500^{th} print was compared with the 600^{th} print. An image deterioration level of a 10-50% dot image portion and a solid image portion before and after a cleaning treatment was visually evaluated with the following criteria.

A: No image deterioration is substantially observed.

B: Image deterioration is observed at a 10-50% dot image portion.

C: Image deterioration is observed at a solid image portion.

Results are shown in FIG. 2.

TABLE 2

| Printing plate material | | | | | | | | | | | |
|---|---|---|---|---|---|---|---|---|---|---|---|
| | | | | Image formation | | | | | | | |
| | | | | layer | | | | | | | |
| | Support | | | Utilized image | | | Evaluation | | | | |
| | | Subbing | | formation layer | | | Heat | | | | |
| | | layer | | coating solution | | | storing | | Printing | | |
| | | Phosphobetaine | | | Phosphobetaine | | treatment | | durability | | |
| | | compound | | | compound | | (Presence/ | | (Number of | | |
| No. | No. | No. | (mg/m²) | No. | No. | (mg/m²) | Absence) | *1 | prints) | *2 | Remarks |
| 1 | 1 | — | — | 1 | [1] | 35 | Absence | 15 | at least 20000 | A | Inv. |
| | | | | | | | Presence | 20 | at least 20000 | A | |
| 2 | 1 | — | — | 2 | [2] | 50 | Absence | 15 | at least 20000 | A | Inv. |
| | | | | | | | Presence | 20 | at least 20000 | A | |
| 3 | 1 | — | — | 3 | [2] | 75 | Absence | 15 | at least 20000 | A | Inv. |
| | | | | | | | Presence | 15 | at least 20000 | A | |
| 4 | 1 | — | — | 4 | [1] | 60 | Absence | 20 | at least 20000 | A | Inv. |
| | | | | | | | Presence | 20 | at least 20000 | A | |
| 5 | 2 | [1] | 20 | 5 | — | — | Absence | 20 | at least 20000 | A | Inv. |
| | | | | | | | Presence | 25 | at least 20000 | A | |
| 6 | 3 | [2] | 15 | 5 | — | — | Absence | 20 | at least 20000 | A | Inv. |
| | | | | | | | Presence | 30 | at least 20000 | A | |
| 7 | 2 | [1] | 20 | 3 | [2] | 75 | Absence | 15 | at least 20000 | A | Inv. |
| | | | | | | | Presence | 15 | at least 20000 | A | |
| 8 | 1 | — | — | 5 | — | — | Absence | 35 | at least 20000 | A | Comp. |
| | | | | | | | Presence | at least | at least 20000 | A | |
| | | | | | | | | 500 | | | |
| 9 | 1 | — | — | 6 | — | — | Absence | 30 | 10000 | C | Comp. |
| | | | | | | | Presence | 40 | 13000 | B | |

Comp.: Comparative example,
Inv.: Present invention
*1: On-press developability (Number of prints),
*2: Resistance to chemicals

As is clear from Table 2, it is to be understood that a printing plate material of the present invention exhibits excellent on-press developability even after a thermal storing treatment, together with excellent printing durability and resistance to chemicals.

### Example 2

### [Preparation of Support 4]

Support 1 was immersed in a processing liquid containing 0.5% by weight of phosphobetaine compound [1], subsequently washed with pure water, and dried at 80° C. for 2 minutes to obtain Support 4. Similarly to printing plate material 5 (Sample No. 5), an image formation layer was coated on Support 4 to obtain printing plate material 10. When the same evaluation as in Example 1 was conducted, despite presence or absence of the thermal storing treatment, obtained were excellent results such as 20 prints of development-on-press, 20,000 prints of printing durability and rank A of resistance to chemicals.

### Example 3

### [Preparation of Support 5]

A 0.24 mm thick aluminum plate (material 1050, refining H16) was immersed in an aqueous 1% by weight sodium hydroxide solution at 50° C. to give an aluminum dissolution amount of 2 g/m², washed with water, immersed in an aqueous 0.1% by weight hydrochloric acid solution at 25° C. for 30 seconds to neutralize, and then washed with water.

Subsequently, the aluminum plate was subjected to an electrolytic surface-roughening treatment in an electrolytic solution containing 10 g/liter of hydrochloric acid, 10 g/liter of acetic acid and 5 g/liter of aluminum at a peak current density of 50 A/dm² employing an alternating current with a sine waveform, in which the distance between the plate surface and the electrode was 10 mm. The electrolytic surface-roughening treatment was divided into 8 treatments, in which the quantity of electricity used in one treatment (at a positive polarity) was 40 C/dm², and the total quantity of electricity used (at a positive polarity) was 320 C/dm². Standby time of 4 seconds, during which no surface-roughening treatment was carried out, was provided after each of the separate electrolytic surface-roughening treatments.

Then, the resulting aluminum plate was immersed in an aqueous 1% by weight sodium hydroxide solution at 50° C., and etched to give an aluminum etching amount (including smut produced on the surface) of 2 g/m², washed with water, and then immersed in an aqueous 10% by weight sulfuric acid solution at 25° C. for 10 seconds.

Subsequently, the aluminum plate was subjected to anodizing treatment in an aqueous 20% by weight sulfuric acid solution at 25° C. at a current density of 5 A/dm² to form an anodization film having a coating amount of 2 g/m², and washed with water.

Next, the washed surface of the plate was squeegeed, and the plate was immersed in an aqueous 0.5% by weight Lithium Silicate 45 (produced by Nissan Chemical Industries, Ltd.) solution for 20 seconds, and dried at 80° C. for 5 minutes after washing with water to obtain Support 5. Surface roughness Ra of Support 5 was 0.33 μm.

### [Preparation of Support Comprising a Hydrophilic Layer Containing Inorganic Binder]

### Preparation of Pigment Particle Dispersion

The following materials were dispersed at 1500 rpm for 2 hours employing a sand grinder. Zirconia beads having a bead diameter of 1 mm were employed as a dispersion media. After a dispersing treatment, the beads were removed, and filtered to obtain a pigment particle dispersion having a solid content of 50% by weight. The pigment particle dispersion has become one dispersed approximately to a primary particle level.

TABLE 3

| | Content |
|---|---|
| | (weight |
| Materials | ratio) |
| Fe—Ti based composite metal oxide ETB-300 | 49.00 |
| (produced by Titan Kogyo Kabushiki Kaisha; an | |
| average particle diameter of 0.5 μm) | |
| 5% by weight of gel obtained by being swelled in | 15.00 |
| water while vigorously stirring a layer structural | |
| mineral Montmorillonite: Mineral Colloid MO | |
| (produced by Southern Clay Products Co., Ltd.; an | |
| average particle size of about 0.1 μm) employing a | |
| homogenizer. | |
| Aqueous 10% by weight trisodium phosphate•12-water | 2.50 |
| solution (reagent produced by Kanto Chemical Co., | |
| Inc.) | |
| Pure water | 33.50 |

### [Preparation of Hydrophilic Layer Coating Solution]

After materials other than a surfactant among the following materials in Table 4 were sufficiently mixed and dispersed, a surfactant was added while further stirring, and the resulting was filtered to prepare each of hydrophilic layer coating solutions having a solid content of 30% by weight.

### Hydrophilic layer coating solution composition (Values with no unit in the table represent “parts”.

TABLE 4

| | | Hydrophilic | Hydrophilic | Hydrophilic |
|---|---|---|---|---|
| | | layer | layer | layer |
| | | coating | coating | coating |
| Materials | | solution 1 | solution 2 | solution 3 |
| Metal | Porous aluminosilicate: | 1.50 | 1.80 | 1.50 |
| oxide | JC40 (produced by | | | |
| particle | Mizusawa Kagaku Co., Ltd.; | | | |
| | an average particle | | | |
| | diameter of 4 μm) | | | |
| Metal | Pigment dispersion | 33.00 | 33.00 | 33.00 |
| oxide | (a solid content of 50% by | | | |
| particle | weight) | | | |
| exhibiting | | | | |
| light-to- | | | | |
| heat | | | | |
| capability | | | | |
| Binder | Necklace-shaped colloidal | 30.00 | 27.00 | 30.00 |
| | silica (alkali type): | | | |
| | Snowtex-PSM (produced by | | | |
| | Nissan chemical | | | |
| | Industries, Ltd.; a solid | | | |
| | content of 20% by weight) | | | |
| | Colloidal silica (alkali | 12.40 | 11.90 | 12.90 |
| | type): Snowtex-S | | | |
| | (produced by Nissan | | | |
| | chemical Industries, Ltd.; | | | |
| | a solid content of 30% by | | | |
| | wejght) | | | |
| | Aqueous lithium silicate | 10.50 | 10.50 | 10.50 |
| | solution: LSS35 (produced | | | |
| | by Nissan chemical | | | |
| | industries, Ltd.; a SiO₂ | | | |
| | content of 20% by weight) | | | |
| Water- | Water-soluble phospho- | 3.00 | 12.00 | 0.00 |
| soluble | Betaine compound [1] | | | |
| phosphobetaine | Aqueous 5% by weight | | | |
| compound | solution | | | |
| Surfactant | Surfinol 485 | 3.00 | 3.00 | 3.00 |
| | (produced by Air Products | | | |
| | and chemicals, Inc.) | | | |
| | Aqueous 1% by weight | | | |
| | solution | | | |

| | | | |
|---|---|---|---|
| Pure water | 6.60 | 0.80 | 9.10 |

### [Preparation of Supports 6-8]

Each of hydrophilic layer coating solutions 1-3 was coated onto Support 5 so as to give a dry coating amount of 3.0 g/m², and dried at 120° C. for one minute, and an aging treatment was subsequently conducted at 60° C. for 24 hours to obtain Supports 6-8.

### [Preparation of Support 9]

Support 8 was immersed similarly to Support 4 to obtain Support 9.

### [Preparation of Image Formation Layer Coating Solutions 7-9]

### Heat Melting Compound (B): Preparation of a Mixture Dispersion of Wax Emulsion Particles and an Infrared Absorbing Dye

Carnauba wax emulsion A118 (having an average particle size of 0.3 μm, a softening point of 65° C., a melting point of 80° C., a melting viscosity at 140° C. of 8 cps, and a solid content of 40% by weight; and produced by Gifu Shellac Mfg. Co., Ltd.) was employed as a heat melting compound. The A118 was diluted with water while stirring to prepare a solid content of 10% by weight. Fifteen parts of a 1% by weight infrared absorbing dye 2 (having the following structure) IPA solution were dripped for 5 minutes while stirring 48.5 parts of the resulting. While further stirring, 36.5 parts of pure water was added to obtain a mixture dispersion having a solid content of 5% by weight. Next, each of materials in Table 5 was sufficiently mixed while stirring, and filtered to obtain each of image formation layer coating solutions having a solid content of 5% by weight.

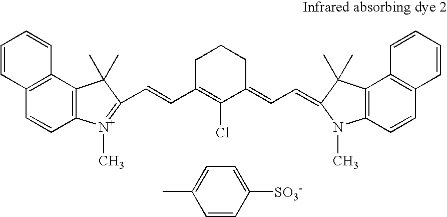

### Compositions of image formation layer coating solutions 1-3 (Values with no unit in the table represent “parts”.

TABLE 5

| | Image | Image | Image |
|---|---|---|---|
| | formation | formation | formation |
| | layer | layer | layer |
| | coating | coating | coating |
| Materials | solution 7 | solution 8 | solution 9 |
| Mixture dispersion of heat | 85.00 | 81.00 | 80.00 |
| melting compound (B) | | | |
| (a solid content of 5% by | | | |
| weight) | | | |
| 5% by weight water-soluble | 1.00 | 5.00 | |
| phosphobetaine compound [1] | | | |
| solution | | | |
| Aqueous 10% by weight | 2.00 | 2.00 | 5.00 |
| hydroxyalkylated starch | | | |
| (Penon JE-66, produced by | | | |
| Nippon Starch Chemical Co., | | | |
| Ltd.) solution | | | |
| Aqueous 10% by weight | 5.00 | 5.00 | 5.00 |
| disodium | | | |
| hydrogenphosphate.12-water | | | |
| solution | | | |
| Pure water | 7.00 | 7.00 | 10.00 |

Employing the combination provided in Table 6, each of image formation layer coating solutions was coated on each support so as to give a dry coating amount of 0.6 g/m² employing a wire bar, and dried at 60° C. for one minute. Next, an aging treatment was conducted at 50° C. for 24 hours to obtain each of printing plate material samples.

### [Exposure Employing Infrared Laser]

Each of the printing plate material samples was mounted on an exposure drum, and imagewise exposed. The exposure was carried out employing an infrared laser (having a wavelength of 830 nm and a beam spot diameter of approximately 18 μm) at a resolution of 2400 dpi (“dpi” herein shows the number of dots per 2.54 cm) and at a screen line number of 175 to form an image. The image pattern used for exposure had a solid image, a dot image with a dot area of 1-99%, and a gradation image of 0-100%. The image ratio was set to 30% (having a non-image portion of 70%). Exposure energy was 150 mJ/cm².

### [Image Formation Via Ink-Jet]

(Preparation of actinic radiation curable ink-jet ink)

| | |
|---|---|
| After compositions of the following ink were mixed and | 5 parts |
| stirred, the resulting liquid was filtered to obtain ink. | |
| Colorant: CI pigment Blue 15:3 | |
| (an average dispersed particle diameter of 100 nm) | |
| Cetyl acrylate | 30 parts |
| Polyethylene glycol diacrylate | 25 parts |
| (an average polymerization degree of 9) | |
| Phenoxyethyl acrylate | 15 parts |
| Isobonyl methacrylate | 25 parts |
| IRGACURE 184 (1-hydroxycyclohexylphenylketone, | 2.5 parts |
| Produced by Ciba specialty Chemicals Co., Ltd.) | |
| LUCIRIN TPO (monoacylphosphineoxide, | 2.5 parts |
| Produced by BASE) | |

### (Preparation of Printing Plate)

The resulting ink was printed on Supports 7 and 8 (which have been subjected to an aging treatment at 60° C. for 24 hours) employing an ink-jet recording device equipped with a piezoink head (heated to 60° C.), and exposed to UV rays employing a UV ray exposure device (a metal halide lamp with an output power of 120 W) to cure ink. The support conveyance speed was set to 10 m/minute. The image of 720 dpi had a solid image, a dot image corresponding to a dot area of 50%, and the image ratio was set to 30% (having a remaining non-image portion) to obtain printing plates A and B.

### [Water-Soluble Phosphobetaine Compound Provided After Forming Image Portion]

A water-soluble phosphobetaine compound was provided after forming image portions employing an automatic developing machine Raptor 85T (manufactured by Glunz & Jensen Inc.). Pure water was employed for a developing portion of the automatic developing machine as the processing liquid, and an aqueous 1% by weight phosphobetaine compound [1] solution was employed for a gum treatment portion as the processing liquid. The processing speed was set to 120 cm/minute. Drying temperature after the gum treatment was set to 55° C. Printing plate B was introduced into an automatic developing machine with this setting to obtain printing plate C.

### [Printing Evaluation]

Printing up to 100 prints was conducted similarly to Example 1. The non-image portion of the 20^{th} print after the beginning of printing was visually evaluated.

A: No background contamination is observed.

B: Background contamination is slightly observed.

C: Background contamination is clearly observed.

Standby time of one hour in printing was provided after printing 100 prints. The printing press was operated at low speed during standby time (each of plate cylinders and rollers operated at low speed). After one hour, printing was restarted in the same sequence as at the beginning of printing to print 100 prints after restarting. A non-image portion of the 20^{th} print via restart of printing after standby time was similarly observed for evaluation. Results are shown in Table 6. As is clear from Table 6, it is to be understood that printing plates of the present invention do not produce background contaminations, even though the printing press is placed under the heavy-duty condition such as standby time of one hour.

TABLE 6

| | | | | | Background | | |
|---|---|---|---|---|---|---|---|
| | | | | | contamination | | |
| Printing | | | | | of | | |
| plate | | Image | | | the 20^{th} | | |
| or | | formation | | | print | | |
| printing | | layer | Ink- | Water- | after the | | |
| plate | | coating | jet | soluble | beginning | | |
| material | | solution | Image | phosphotetaine | of | | |
| No. | Support | No. | formation | compound | printing | *1 | *2 |
| 11 | 6 | 7 | | Not | A | A | Inv |
| | | | | provided | | | |
| 12 | 7 | 9 | | Not | A | A | Inv |
| | | | | provided | | | |
| 13 | 8 | 8 | | Not | A | A | Inv |
| | | | | provided | | | |
| 14 | 8 | 9 | | Not | A | C | Comp |
| | | | | provided | | | |
| 15 | 9 | 9 | | Not | A | A | Inv |
| | | | | provided | | | |
| 16 | 9 | 8 | | Not | A | A | Inv |
| | | | | provided | | | |
| A | 7 | | Provided | Not | A | A | Inv |
| | | | | provided | | | |
| B | 8 | | Provided | Not | A | C | Comp |
| | | | | provided | | | |
| C | 8 | | Provided | provided | A | A | Inv |

*1: Background contamination of the 20^{th} print via restart of printing after standby time
*2: Present inventin (Inv)/Comparative example (Comp)

### Example 4

The following photosensitive layer coating solution was coated onto Support 1 employing a wire bar, and dried at 95° C. for 90 seconds. The coating amount of the photosensitive layer was set to 1.5 g/m². A positive-working thermal type printing plate material was obtained here.

(Photosensitive layer coating solution)

| | | |
|---|---|---|
| Novolac resin (m-cresol/p-cresol = 60/40, | 1.0 | parts |
| weight average molecular weight: 7000, | | |
| and an unreacted cresol content of 0.5% by weight) | | |
| Infrared absorbing agent D-5 | 0.1 | parts |
| Tetrahydrophthalic anhydride | 0.05 | parts |
| p-toluenesulfonic acid | 0.002 | parts |
| 6-hydroxy-β-naphthalene sulfonate | 0.02 | parts |
| made from counter ion of ethylviolet | | |
| fluorine based surfactant (F178K, produced by | 0.5 | parts |
| by Dainippon Ink and Chemicals, Inc.) | | |
| methylethyl ketone | 12 | parts |

### [Exposure Employing Infrared Laser]

The resulting printing plate material sample was mounted on an exposure drum, and imagewise exposed. The exposure was carried out employing an infrared laser (having a wavelength of 830 nm and a beam spot diameter of approximately 18 μm) at a resolution of 2400 dpi (“dpi” herein shows the number of dots per 2.54 cm) and at a screen line number of 175 to form an image. The image pattern used for exposure had a solid image, a dot image with a dot area of 1-99%, and a gradation image of 0-100% (the image inverted for a positive print). The image ratio was set to 30% (having a non-image portion of 70%). Exposure energy was 150 mJ/cm².

### (Preparation of Printing Plate)

A developing treatment was conducted employing an automatic developing machine Raptor 85T (manufactured by Glunz & Jensen Inc.) to prepare a printing plate. The following developer was employed for a developing portion of the automatic developing machine, the developing temperature was set to 300° C. A gum liquid in which GW-3 (produced by Mitsubishi Chemical Corporation) was diluted by two times was used for a gum treatment portion. The processing speed was set to 120 cm/minute. Drying temperature after the gum treatment was set to 55° C.

### Developer compositions (an aqueous solution in which the following additives are contained at the following ratio)

| | |
|---|---|
| Potassium salt made from | 50.0 g/liter |
| D-sorbit/potassium oxide K₂O in which | |
| nonreducing sugar is combined with a base | |
| OLEFINE AK-02 (produced by | 0.15 g/liter |
| Nissin Chemical Industry Co., Ltd.) | |
| Water was added to make a 1 liter solution. | |

A positive-working thermal type printing plate material was developed on this condition to obtain printing plate D.

Printing plate E was similarly prepared, except that the gum liquid at a gum treatment portion was replaced by an aqueous 1% by weight phosphobetaine compound [1] solution. Similarly to Example 3, printing was conducted for printing plate D as a comparative example and printing plate E of the present invention. No background contamination of Printing plates D and E was observed at the beginning of printing. No background contamination of printing plates D and E at the beginning of printing via restart of printing was not observed either, but printing plate D had entanglement in a dot image with a dot area of 97-99% observed in the 20^{th} print after restart of printing, and a gradation image of printing plate D was also deteriorated. On the other hand, in the case of printing plate E, neither entanglement in a dot image with a dot area of 97-99% nor deterioration of a gradation image was observed. Thus, it is to be understood that printing plates of the present invention exhibit excellent printability regardless of the image formation layer type.

### EFFECT OF THE INVENTION

The present invention can provide a planographic printing plate material exhibiting excellent properties such as printing durability, resistance to chemicals and anti-stain at the beginning of printing via restart of printing, and also a planographic printing plate exhibiting excellent properties such as printing durability, resistance to chemicals and anti-stain at the beginning of printing via restart of printing.

What is claimed is:

1. A planographic printing plate comprising a support and provided thereon, an image portion and a non-image portion,
wherein the non-image portion comprises a water-soluble phosphobetaine compound.

2. The planographic printing plate of claim 1,
wherein the water-soluble phosphobetaine compound is a compound comprising a group represented by the following Formula (2): 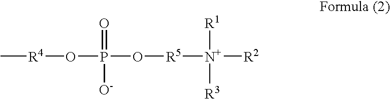
wherein R¹, R² and R³ each are the same group or a different group, representing an alkyl group or a hydroxyalkyl group having 1-8 carbon atoms; R⁴ represents —(CH₂—CHR⁶O)ₘ—(CH₂—CHR⁶)— where R⁶ represents a hydrogen atom, a methyl group or an ethyl group, and m is an integer of 0-10; and R⁵ represents —(CH₂)_{g}— where g is an integer of 0-10.

3. A planographic printing plate material utilized for the planographic printing plate of claim 1, comprising the support and provided thereon, an image formation layer, and the water-soluble phosphobetaine compound between the support and the image formation layer.

4. The planographic printing plate material of claim 3, wherein the image formation layer comprises the water-soluble phosphobetaine compound.

5. The planographic printing plate material of claim 3, wherein the support comprises a hydrophilic layer containing the water-soluble phosphobetaine compound on an image formation layer side of the support.

6. The planographic printing plate material of claim 3,
wherein the water-soluble phosphobetaine compound is a compound comprising a group represented by the following Formula (2): 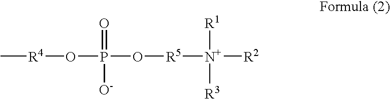
wherein each of R¹, R² and R³ each are the same group or a different group, representing an alkyl group or a hydroxyalkyl group having 1-8 carbon atoms; R⁴ represents —(CH₂—CHR⁶O)ₘ—(CH₂—CHR⁶)— where R⁶ represents a hydrogen atom, a methyl group or an ethyl group, and m is an integer of 0-10; and R⁵ represents —(CH₂)_{g}— where g is an integer of 0-10.

7. A support utilized for the planographic printing plate material of claim 5.

8. A planographic printing method comprising the step of:
conducting a planographic printing process employing the planographic printing plate of claim 1.
